(19) United States
(12) Patent Application Publication
(10) Pub. No.: US 2007/0014506 A1
(43) Pub. Date: Jan. 18, 2007

(54) Fiber optic position transducer with magnetostrictive material and position calibration process

(75) Inventors: Jose Luiz Arias Vidal, Tijuca (BR); Ricardo Munoz Freitas, Tijuca (BR); Arthur Martins Barbosa Braga, Lebion (BR); Luiz Carlos Guedes Valente, Copacabana (BR); Antonio Carlos Oliveira Bruno, Lagoa (BR); Helio Ricardo Carvalho, Inhauma (BR)

Correspondence Address: NIXON & VANDERHYE, PC, 901 NORTH GLEBE ROAD, 11TH FLOOR, ARLINGTON, VA, 22203, US

(73) Assignees: PETROLEO BRASILEIRO S.A. - PETROBRAS; PONTIFICIA UNIVERSIDADE CATOLICA DO RIO DE JANEIRO

(21) Appl. No.: 11/434,517

(22) Filed: May 16, 2006

(30) Foreign Application Priority Data
May 17, 2005 (BR) PI 0501790-4

(51) Int. Cl. G02B 6/00

(52) U.S. Cl. 385/13

(57) ABSTRACT

Fiber optic position transducer that includes a magnetic or electromagnetic element, one or more segments of magnetostrictive material, Fiber Bragg Grating Sensors, a rod of material that is impenetrable to magnetic fields, optical fiber. One or more of the sensors is fixed upon a segment of magnetostrictive material, which is fixed to a rod, and may only be displaced longitudinally. The Fiber Bragg Grating Sensors have different wave lengths and are made of the same optical fiber. The magnetic or electromagnetic element included may be made of NdFeB (Neodymium Iron Boron) or metal alloys of TbDyFe (Terbium, Dysprosium and Iron), such as TX, Terphenol-D and others. It is applied to a control flow valve in an oil well, and it also refers to the calibration process of the position of the transducer.

### CROSS REFERENCE TO RELATED APPLICATION

This application is based upon, claims the benefit of, priority of, and incorporates by reference, the contents of Brazilian Patent Application No. PI 0501790-4 filed May 17, 2005.

### FIELD OF THE INVENTION

The present invention refers to methods of measuring the position of equipment in deep wells in onshore and offshore installations. Specifically it is of application on flow control valves, called “choke”.

### DESCRIPTION OF THE STATE OF THE ART

Some manufacturers have commercially developed fiber optic position transducers based on interferometry or light intensity. Fiso's position transducer falls into this first category, as described in the article, “Fiso'sWhite-Light Fabry-Perot Fiber-Optics Sensors”; Fiso Technologies Inc. The Philtec position transducer, presented in “Philtec Fiber optic Displacements Sensors”, Philtec Inc. 2002, currently uses measurement of light intensity. Other well known devices, that have not reached the commercial stage, are: The transducer on an arm based on interferometry, described by F. Ruan; Y. Zhou; Y. Loy; S. Mei, Ch. Liaw and J. Liu in the article, “A Precision Fiber Optic Displacement Sensor Based on Reciprocal Interferometry”; Optics Communication, No. 176, pp 105-112, 2000, and the transducer based on reflective prisms, describe by Y. Takamatsu; K. Tomota and T. Yamashita in “Fiber-optic Position Sensor; Sensors and Actuators”, N° A21-A23, pp 435-437, 1990.

Transducers that are supported by interferometry depend on an opening from which the light exits the fiber and is reflected by some type of mirror. This presents a weakness, since the mirror can be displaced in relation to the fiber, leading to the need to mechanically align the light beam as well as problems related to the cleanliness of the optical surfaces (tip of the fiber and mirror). Moreover, if dealing with transducers that must be located at the end of the fiber, serial multiplexing is not possible.

The high sensitivity to angular misalignment of the fiber optic line in relation to the surface is one disadvantage of transducers based on light intensity that even require a visually homogeneous target surface, with reduced result precision when the surface is less reflective.

On the other hand, some recent articles describe the use of magnetostrictive materials as a base for the construction of position transducers. The effect of magnetostriction, that occurs in the majority of cases with ferro-magnetic materials, is a variation in the length variation of a segment subject to a magnetic field; the magnetostrictive material expands or contracts in response to changes in the strength of the magnetic field in the area where the segment is found. This effect is symmetrical in relation to the applied field, with distortions in only one direction, independent of the magnetic field signal.

Some applications already exist that use these magnetostrictive materials in the construction of devices for measuring magnetic field and torque, for example, but up until now, there are few that are large enough to use as position sensors. Among these are found patents JP10253399-A and U.S. Pat. No. 6,232,769-Bl, and those that are described in the articles, “Dynamic behavior of Terfenol-D”, by Koshi Kondo; J. of Alloys and Compounds 258 (1997) 56-60; “On the calibration of position sensor based on magnetic delay lines” by E. Hristoforou, H. Chiriac, M. Neagu, V. Karayannis; Sensors and Actuators, A 59 (1997) 89-93; “A coily magnetostrictive delay line arrangement for sensing applications”, by E. Hristoforou, D. Niarchos, H. Chiriac, M. Neagu; Sensors and Actuators A 91 (2001) 91-94 and “New position sensor based on ultra acoustic standing waves in FeSiB amorphous wires”, by H. Chiriac, C. S. Marinescu ; Sensors and Actuators 81 (2000) 174-175. All the cited applications above are based on the principal of acoustic wave propagation through a connecting rod (stem/rod) or waveguide made with magnetostrictive material. The sensor elements are inductive or optic, and position is determined by measuring the time interval related to the position of the emitting element, a bobbin or a magnetic or an electromagnetic element. All require an electronic circuit next to the location of the measurement and have a dynamic range of between 30 mm to 300 mm.

Similarly, the position measuring device described in patent U.S. Pat. No. 5,821,743 is a device that includes a magnetostrictive waveguide that extends through a measured field, and a means to produce a signal that shows the position of a magnet. It is endowed with a piezoceramic element.

Patent U.S. Pat. No. 5,394,488, which presents a speed sensor, and the article “A Magnetostrictive sensor interrogated by fiber gratings for DC-current and Temperature discrimination”, by J. Mora, A. Díez, J. L. Cruz, M. V. Andrés; IEEE Photonics Tech. Letters 12 (2000) 1680-1682, although they are not referring to the measurement of position, they solve the cited problems in a manner related to the present invention, based on the joint use of magnetostrictive material and Fiber Bragg Grating Sensors.

By including the information from its optic specter, Fiber Bragg Grating Sensors supply an absolute measurement that is easily multiplexed, with applications where traditional sensing systems have shown to be inefficient. The wave length variation values of a Fiber Bragg Grating Sensor are related to variations in temperature and distortions through the equation:
Δλ_{B}/λ_{B}−K₁ΔT+K₂ε (I)

where λ_{B} is the value, in meters, of the wavelength reflected by the sensor, ΔT is the temperature variation, in °C., and represents the distortion suffered by the sensor, in m/m, and K₁ and K₂ are constants that depend upon the specific assembly.

Diverse techniques have been used in the different types of position transducers currently known: capacitive, optical, inductive and fiber optic.

The prevailing technique uses electric induction as the functioning principle. The main advantage of this type of position transducer over the others is its highly resistant quality, since due to the absence of physical contact there is little wear on the sensor element. Its great advantage over the previous ones is its capacity to work under severe conditions with no changes in its performance in humid environments and vibrations. Moreover, they are susceptible to electromagnetic interferences.

The most recent technology uses fiber optic support. There is not one, but several techniques which have in common the use of fiber optics as a light guide used for measurement. Among these techniques are those based on Bragg networks, which, until now, has not yet been applied to position transducers.

A great advantage of fiber optic sensors and transducers, beyond its good performance and simplicity of construction, is the absence of electric signals next to the measurement point, which makes these sensors and transducers totally safe for applications in classified areas.

### SUMMARY OF THE INVENTION

The purpose of the present invention is to develop a position transducer based on the Bragg Network technology using highly reliable, robust fiber optics for the outflow control valve on the inside of an oil well.

The purpose of this invention is a fiber optic position transducer for uniaxial movements based on the properties of magnetostrictive and that uses Bragg networks as sensing elements.

A fiber optic position measurement system was developed for uniaxial movements based on Fiber Bragg Grating Sensors and the properties of magnetostrictive material. Changes in the relative position between a magnetic field source and a segment of magnetostrictive material, (connected to Fiber Bragg Grating Sensors) cause changes in the size of this segment, which induces alterations in the wave lengths reflected by the Fiber Bragg Grating Sensors. When the spatial dependence of the magnetic field is known, wave lengths reflected by the sensors will be related to the displacement which has occurred. The invention also refers to the process of calibration of the position of the fiber optic position transducer.

For this, a fiber optic position transducer is foreseen that includes the following components:—a magnetic or electromagnetic element;—at least one segment of magnetostrictive material;—Fiber Bragg Grating Sensors;—a rod of material that is impenetrable to magnetic fields;—optical fiber; being that:—said sensors are at least joined and fixed to a segment of magnetostrictive material;—at least one of said segments of magnetostrictive material is fixed to a rod;—and the distortion of the rod relative to the magnetic or electromagnetic element is limited to the direction of the rod's axis.

### BRIEF DESCRIPTION OF THE DRAWINGS

These and other objects and advantages of this invention, will be more completely understood and appreciated by careful study of the following more detailed description of the presently preferred exemplary embodiments of the invention taken in conjunction with the accompanying drawings, in which:

FIG. 1 is a drawing that shows the basic configuration of the position transducer in accordance with an example embodiment of the present invention. Number 1 of this figure is the performance of the magnetic or electromagnetic element;

FIG. 2 is a drawing that shows the first variation of the basic configuration of the position transducer in accordance with an example embodiment of the present invention;

FIG. 3 is a drawing that shows the second variation of the basic configuration of the position transducer in accordance with an example embodiment of the present invention;

FIG. 4 is a drawing that shows the connection of the modules that are the same as the second variation of the basic configuration of the position transducer in accordance with an example embodiment of the present invention;

FIG. 5 is a drawing that shows the third variation of the basic configuration of the position transducer in accordance with an example embodiment of the present invention;

FIG. 6 is a drawing that shows the connection of the modules that are the same as the third variation of the basic configuration of the position transducer in accordance with an example embodiment of the present invention;

FIG. 7 is an example of a graph with wave length measurements from two Fiber Bragg Grating Sensors in function of position, in the basic configuration of the position transducer in accordance with an example embodiment of the present invention;

FIG. 8 is an example of a graph showing the spatial dependence of the magnetic field in an application of the basic configuration of the position transducer in accordance with an example embodiment of the present invention;

FIG. 9 is an example of a graph that shows the spatial dependence of the magnetic field in an application of the third variation of the basic configuration of the position transducer in accordance with an example embodiment of the present invention;

FIG. 10 is an example of a graph with wave length measurements from two Fiber Bragg Grating Sensors in function of position, in an application of the third variation of the basic configuration of the position transducer in accordance with an example embodiment of the present invention; and

FIG. 11 is an example of a graph relating the difference of the wave length measurements from two Fiber Bragg Grating Sensors with the position, in an application of the third variation of the basic configuration of the position transducer in accordance with an example embodiment of the present invention.

### DETAILED DESCRIPTION OF THE INVENTION

A detailed explanation is given of the fiber optic position transducer with magnetostrictive material and Fiber Bragg Grating Sensors in flow control valves (choke), suitable for use in onshore and offshore installations of deep wells.

It is a position transducer resistant to high pressures and temperatures, with high sensitivity, simple construction, compact, using Fiber Bragg Grating Sensors (FBG) with magnetostrictive material.

The principle upon which the present invention is based has to do with the relative displacement between a magnetic field source and a segment of magnetostrictive material, which is connected to one or more Fiber Bragg Grating Sensors. Changes in the relative position between a magnetic field source and a segment of magnetostrictive material cause changes in the size of this segment and, for this reason, in the sensor to which it is connected, which induces alterations in the wave lengths reflected by the Fiber Bragg Grating Sensors. Once the spatial dependence of the magnetic field is known, the wave lengths reflected by the sensor are related to the displacement which has occurred.

As the temperature is a factor that can also cause alterations in the wave length of a Fiber Bragg Grating Sensor, the harmonizing device for the present invention is characterized by the use of at least two Fiber Bragg Grating Sensors, to guarantee the necessary compensation for the effect of the temperature.

The other characteristics of the present invention are:
The performance of the sensor can be made of a permanent magnet and/or by the application of a magnetic field.
Preferably, the Fiber Bragg Grating Sensors are made of the same optical fiber. This is advantageous due to its pure simplicity, allowing optical connection elements to be dispensed with, and due to the possibility of measuring other lengths throughout this same fiber.

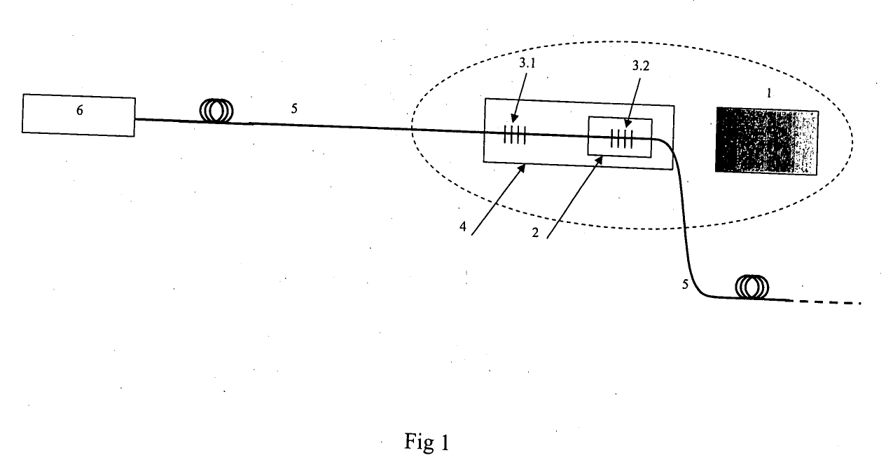

A graph of the basic configuration of the position transducer in accordance with an example embodiment of the present invention, is shown in FIG. 1. A magnetic or electromagnetic element, hereinafter called magnet 1, preferably made of NdFeB (Neodymium Iron Boron), and a rod 4, of material impermeable to magnetic fields, are aligned so that they may suffer relative displacement only along the axis defined for rod 4. A segment of magnetostrictive material 2 is fixed to the end of the rod 4, which may be made of, for example, a metal alloy of TbDyFe (Terbium, Dysprosium and Iron), such as TX, Terphenol-D or others. The magnet 1 and the end of the rod 4 must be close enough to each other so that the relative displacements between them causes variations in the dimensions of the segment of magnetostrictive material 2, measurable by the reading system 6. Fiber Bragg Grating Sensors 3.1 and 3.2 must have different wave lengths, equal respectively to λ₁ and λ₂, and should be made of the same optical fiber 5. In the basic configuration of the invention presented in FIG. 1, only one of the Fiber Bragg Grating Sensors (3.1 or 3.2) is fixed to the segment of magnetostrictive material 2. It does not matter which of the sensors is fixed, it could be the first or second one. The method of fixation may be made, for example, using epoxy or cyanoacrylic glue, or by some other method that may be used to connect the sensors to segments whose distortions or temperature range you wish to measure. Only as an example, in FIG. 1, Sensor 3.2 is fixed to a segment of magnetostrictive material 2, while Sensor 3.1 is free. This means that only Sensor 3.1 will undergo alterations in its λ₁ wave length, in function of possible changes of temperature, while sensor 3.2, in addition to this type of alteration, will also have its λ₂ wave length modified when suffering deformations following the expansion or contraction of the segment of magnetostrictive material 2 caused by changes in the magnetic field.

Only as an example, in FIG. 1, Sensor 3.2 is presented in the axial direction, aligned to the axis defined for rod 4. Since a magnetostrictive material undergoes changes in size in reaction to variations in the magnetic field in which it is immersed, keeping, however, its volume constant, sensor 3.2 (which is fixed to the segment of magnetostrictive material 2), may be aligned in any direction, inasmuch as this is only one of the directions.

The Reading system 6 sends a beam of light through the optical fiber 5. When it reaches sensor 3.1, part of the incident light is reflected in the λ₁ wave length of sensor 3.1, while the remaining part of the light is transmitted, arriving at sensor 3.2. When the light falls on sensor 3.2, the same process occurs: part of the incident light is reflected in the λ₂ wave length of sensor 3.2, and the remaining part of the light is transmitted, following along the optical fiber 5. The light reflected by each of the sensors (3.1 and 3.2) is recaptured by the reading system 6, where it is analyzed.

One possible configuration for the reading system 6 contains a broadband light source, a coupler and an analysis and detection system. As an alternative, the position transducer in accordance with an example embodiment of the present invention may operate connected to any applicable configuration for the interrogation of Fiber Bragg Grating Sensors.

When a displacement between the magnet 1 and the rod 4 occurs, the reading system 6 will present a different reading of λ₂.

If there is a variation in temperature in the area of sensors 3.1 and 3.2, the reading system 6 will present different readings of λ₁ and λ₂ respectively. The device in accordance with an example embodiment of the present invention is pre-calibrated by temperature, that is, curves that give information on variations of λ₁ and λ₂ with the temperature are previously know. In this basic configuration of the present invention, pre-calibration is carried out at Sensor 3.2, which is fixed to the segment of magnetostrictive material 2, in such a way that the temperature calibration curve for Sensor 3.2 will already take into account the effect of thermal distortion on the segment of magnetostrictive material 2. Since there should be no temperature gradient in the short distance between Sensors 3.1 and 3.2, when equation (I) is applied successively to sensors 3.1 and 3.2, it allows temperature compensation and the identification of the range of the λ₂ portion which is exclusively due to the effect the magnetic field has on the segment of magnetostrictive material 2.

The values that the λ₂ wave length takes on as a function of the relative position of rod 4 to magnet 1, with the possible effect of temperature already deducted, provide a calibration curve of the position of the device in accordance with an example embodiment of the present invention, in the basic configuration shown in FIG. 1.

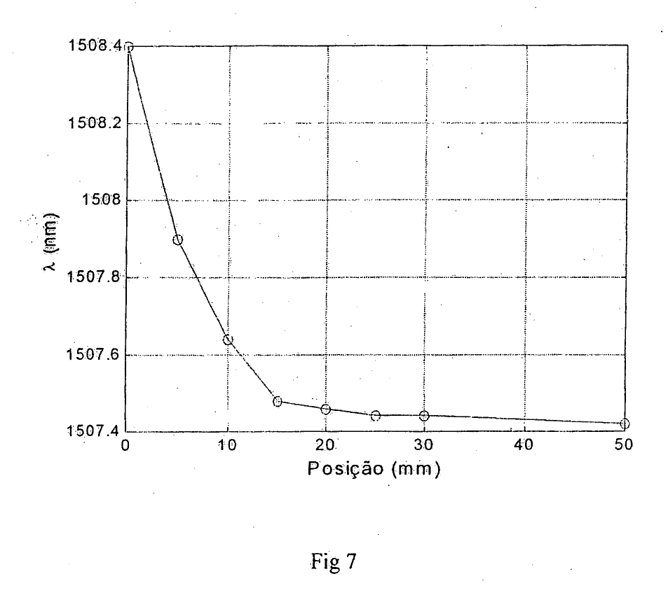

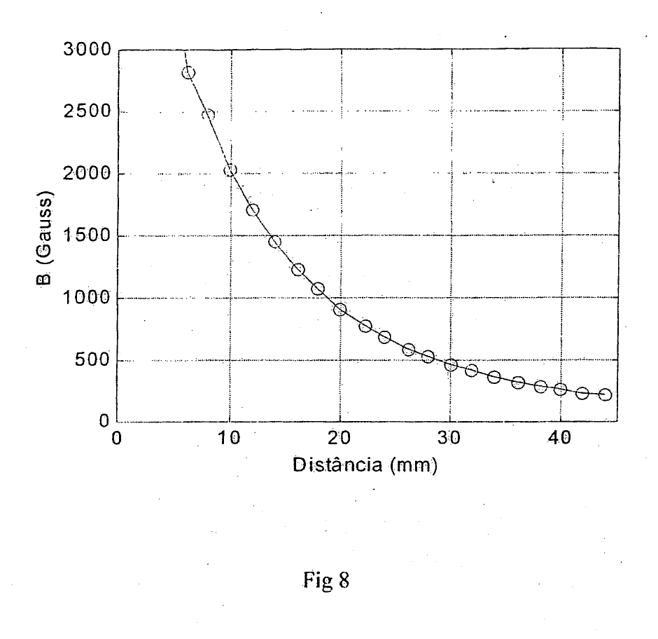

The graph of FIG. 7 is an example of a calibration curve, built from an application of the basic configuration of the present invention, using a solid magnet 1. Point zero of the position mark is placed in magnet 1 next to the segment of magnetostrictive material 2. This element generates a magnetic field such as the one presented, in function of the axial distance in the graph in FIG. 8. Since in this application the field decays along the axial length, the increase in the relative distance between the rod 4 and the magnet 1 causes a reduction in the size of the segment of magnetostrictive material 2 in the axial direction. If the temperature remains constant, and Sensor 3.2 stays aligned in the axial direction, as exemplified in FIG. 1's drawing, a reduction in the value of λ₂ will occur. This is what is shown in the curve of FIG. 7, including compensation of the previously described temperature.

In the case of all three variants of the basic configuration of the present invention described below, the passage of the light is the same as previously described for the basic configuration of the invention: part of the light emitted by the reading system 6 is reflected by Sensors 3.1 and 3.2 in their respective wave lengths, λ₁ and λ₂, and then returns to the reading system 6, where it is analyzed.

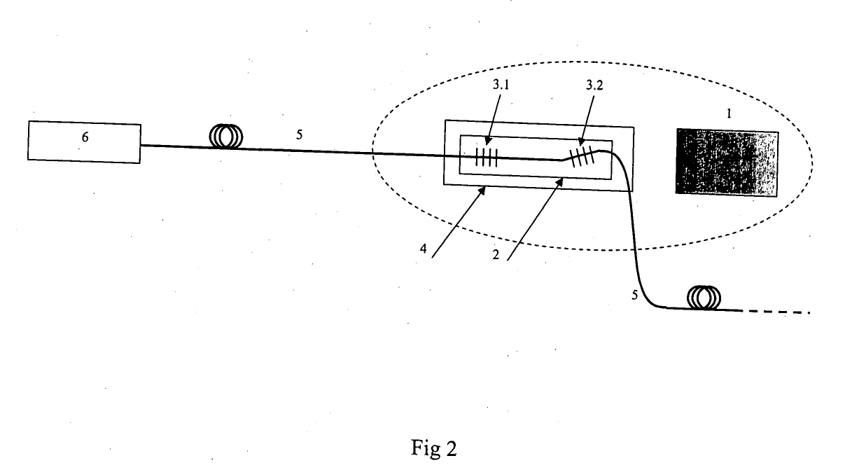

In the first variant of the basic configuration of the present invention, diagramed in FIG. 2, the only difference between it and the basic configuration as seen in FIG. 1 is that, in this variant, the two Fiber Bragg Grating Sensors, 3.1 and 3.2, are fixed upon the segment of magnetostrictive material 2. In this configuration (FIG. 2), sensors 3.1 and 3.2 must be aligned in different directions. They should not be parallel. In this way, when a relative displacement occurs between the magnet 1 and the rod 4, both sensors 3.1 and 3.2 will suffer deformations accompanied by the magnetic effects on the segment of magnetostrictive material 2, but different. Each of the Sensors, 3.1 and 3.2, is will be accompanied by size alterations in the segment of magnetostrictive material 2 in the direction in which the Sensor, be it 3.1 or 3.2, is aligned. In this way, in the variant shown in FIG. 2, when a displacement between the magnet 1 and the rod 4 occurs, the reading system 6 will then present different readings for λ₁ and λ₂, respectively. There will be a range of temperature variations in the region of the Sensors, the reading system 6 will also present a range of readings from λ₁ and λ₂, but this range does not follow the same pattern of variation due to the relative change of position between the magnet 1 and the rod 4.

The distinct distortions caused by the magnetic effect on sensors 3.1 and 3.2 are related by the constant volume of the magnetostrictive material segment 2. As described above, the device in accordance with an example embodiment of the present invention is pre-calibrated by temperature. In this first variant (FIG. 2) of the basic configuration of the present invention, pre-calibration is carried out at Sensors 3.1 and 3.2, which are fixed to the segment of magnetostrictive material 2, in such a way that the respective temperature calibration curve for these Sensors will already take into account the effect of thermal distortion on the segment of magnetostrictive material 2. With the wave length values reflected by Sensors 3.1 and 3.2, and the information regarding the distortion suffered by each sensor, the same equation (I) is applied for each of the sensors, carrying out the same process for compensation of the effects of the previously described temperature for the basic configuration of the present invention. Since wave lengths λ₁ and λ₂ are linked in function with the volume of the magnetostrictive material segment 2, it does not matter whether λ₁ or λ₂ is used to construct a calibration curve for the position of the device. The wave length values chosen, be they λ₁ or λ₂, assuming the function of the position of rod 4 relative to magnet 1, with the possible effects of temperature already deducted, will provide a calibration curve of the position of the device in accordance with an example embodiment of the present invention, in the first is variant shown in FIG. 2.

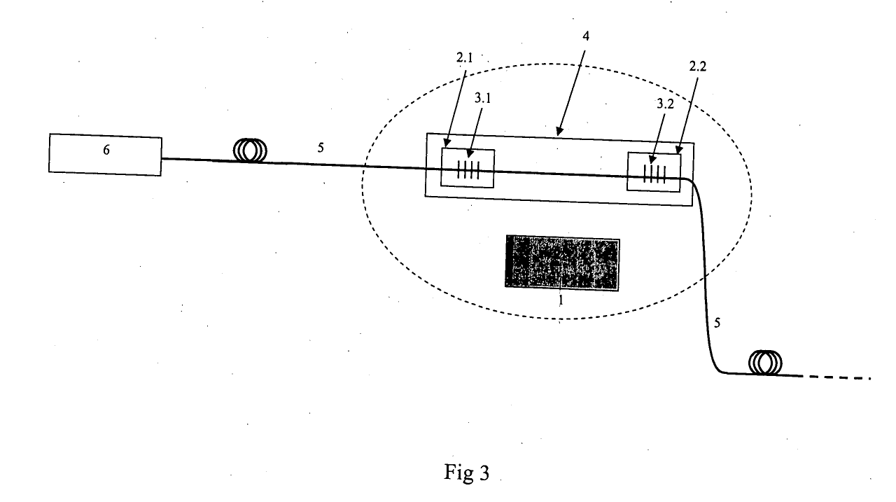

A second variant of the basic configuration of device in accordance with an example embodiment of the present invention is presented in FIG. 3. This variant may be seen as a result of connecting two equal modules in the basic configuration of the invention as diagramed in FIG. 1, except that instead of using only one segment of magnetostrictive material 2, in this variant in FIG. 3, two equal segments of magnetostrictive material, 2.1 and 2.2, each one fixed to one of the ends of the rod 4. On each one of the segments of magnetostrictive material (2.1 and 2.2), a Fiber Bragg Grating Sensor (3.1 or 3.2) is fixed, respectively. In the FIG. 3 drawing, Sensors 3.1 and 3.2 are presented as going in the same direction, parallel to the rod 4, only as an example of a method of easy alignment. Sensors 3.1 and 3.2 may be oriented in other directions, and may be different from each other. Making a more complex choice does not offer greater advantages. Magnet 1 is positioned parallel with the rod 4, in such a way that relative displacements between both occur in only one direction as determined by the rod 4. In this configuration of the invention (diagramed in FIG. 3), segments of magnetostrictive material 2.1 and 2.2 will undergo different distortions in function of the different positions of each one in relation to the magnet 1.

Compared with the basic configuration of the present invention, presented in FIG. 1, and with the first variant, diagramed in FIG. 2, this variant, shown in FIG. 3, presents the advantage of allowing an extension of the dynamic range, as a reduction of the magnetic field's effect on the segment of magnetostrictive material 2.1, for example, due to a a great distance between this segment and magnet 1, it may be compensated by increasing such effect on the segment of magnetostrictive material (2.2), due to the resulting approximation between the other segment and the magnet 1.

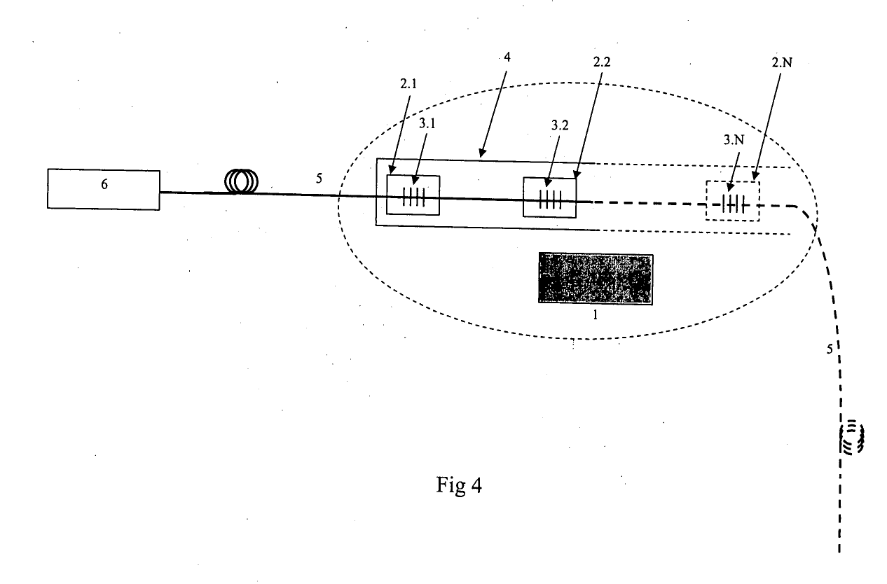

This configuration of the present invention, diagramed in FIG. 3, also makes it possible to extend the dynamic range even more through connecting several modules like these. Several Fiber Bragg Grating Sensors, with different wave lengths, are each fixed upon one of the various segments of magnetostrictive material spaced along the rod 4, as shown in the drawing of FIG. 4. The alterations in the wave lengths of the various sensors, captured by the reading system 6, supply information on the relative displacement between the magnet 1 and the rod 4. The number of sensors to be used, the distances between them and the values of their wave lengths must be calculated in function of a specific given application. The calibration relative to the position for this set of various connected modules will be described below in more detail.

The device, in accordance with an example embodiment of the present invention, is pre-calibrated by temperature, as previously described. In this second variant of the basic configuration of the invention, the pre-calibration is carried out through the two sensors, 3.1 and 3.2, respectively, fixed upon the segments of magnetostrictive materials (2.1 and 2.2), so that the respective calibration curves of these temperature sensors have already taken the effects of the thermal distortion of the respective segments of magnetostrictive material (2.1 and 2.2) into account. With the values of the reflected wave lengths from sensors 3.1 and 3.2, and the information referring to the deformations undergone by each sensor, equation (I) is applied to each one of the sensors. The procedure for calibrating the variant position for this second variant of the device will be described in detail below, together with the description of the third variant of the device in accordance with an example embodiment of the present invention.

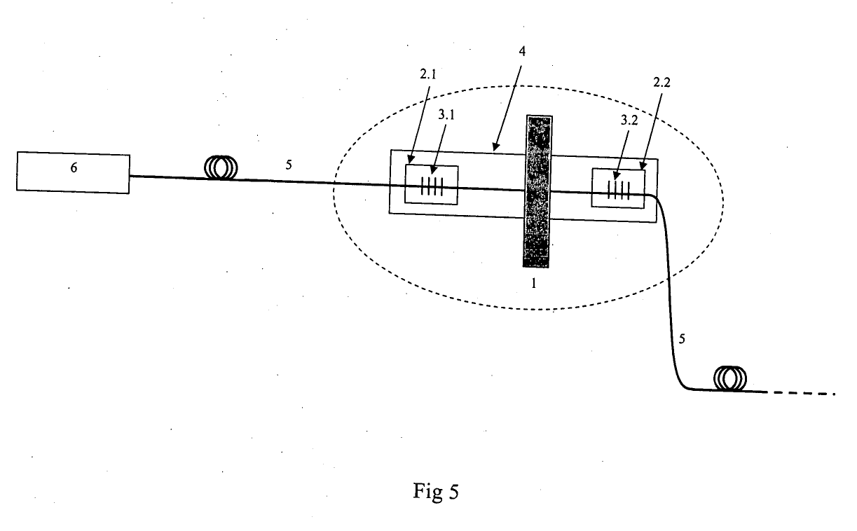

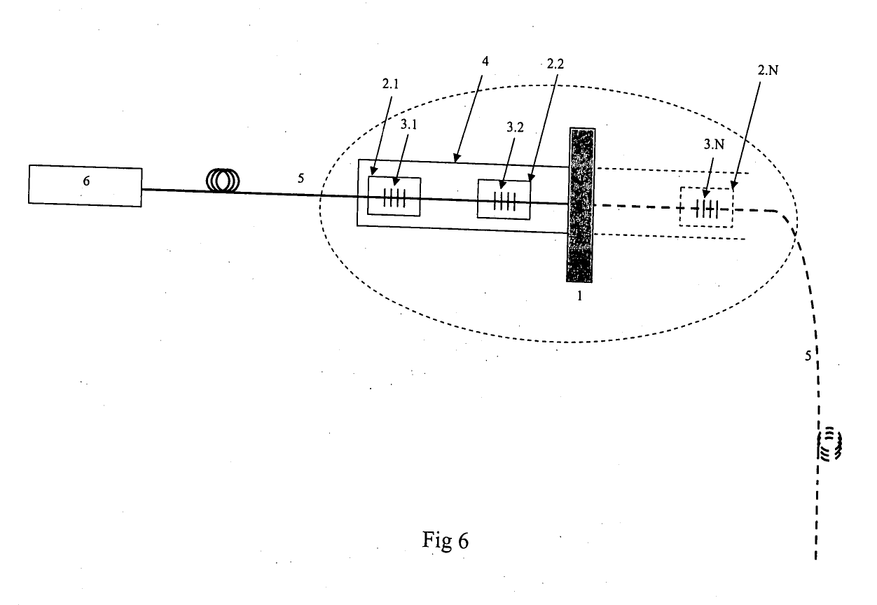

A third variant of the basic configuration of the device in accordance with an example embodiment of the present invention is presented in FIG. 5. In this variant, the segments of magnetostrictive material 2.1 and 2.2, as well as the Fiber Bragg Grating Sensors 3.1 and 3.2 are placed on the ends of the rod 4, in the same way as described previously regarding the second variant of the basic configuration of the present invention. In a similar way, the relative displacement between the magnet 1 and the rod 4 is conveyed along the axis as defined by the rod 4. However, in this configuration of FIG. 4, the magnet 1, which may be in cylindrical format, for example, has a hole, preferably in the center, so that the rod 4 may pass through it. Compared with a configuration where the magnet 1 runs outside the rod 4, as in the diagram in FIG. 3, the configuration shown in FIG. 5 shows the advantage of providing greater proximity between the magnet 1 and the segments of magnetostrictive material (2.1 and 2.2), which intensifies the magnetic field, causing an increase in the dynamic range. Moreover, an analogous form has already been described in the second variant. This third variant of the basic configuration of the present invention, diagramed in FIG. 5 also makes it possible to extend the dynamic range even more through connecting several modules like these. FIG. 6 shows the diagram of the connection of modules like the third variant of the basic configuration of the invention. The relative calibration of the position for this set of various connected modules will be given by a sequence of calibration curves, each of which are constructed using a pair of consecutive sensors, covering, in this way, the entire length of the Rod. The construction of the calibration curve for the pair of sensors (3.1 and 3.2) will be described in detail below.

In this third variant of the basic configuration of the invention, the pre-calibration is based on temperature and is carried out in the same manner as described previously for the second variant, through the two sensors, 3.1 and 3.2, respectively, fixed upon the segments of magnetostrictive materials (2.1 and 2.2), so that the respective calibration curves of these temperature sensors have already taken the effects of the thermal distortion of the respective segments of magnetostrictive material (2.1 and 2.2) into account. With the values of the reflected wave lengths from sensors 3.1 and 3.2, and the information referring to the deformations undergone by each sensor, equation (I) is applied to each one of the sensors.

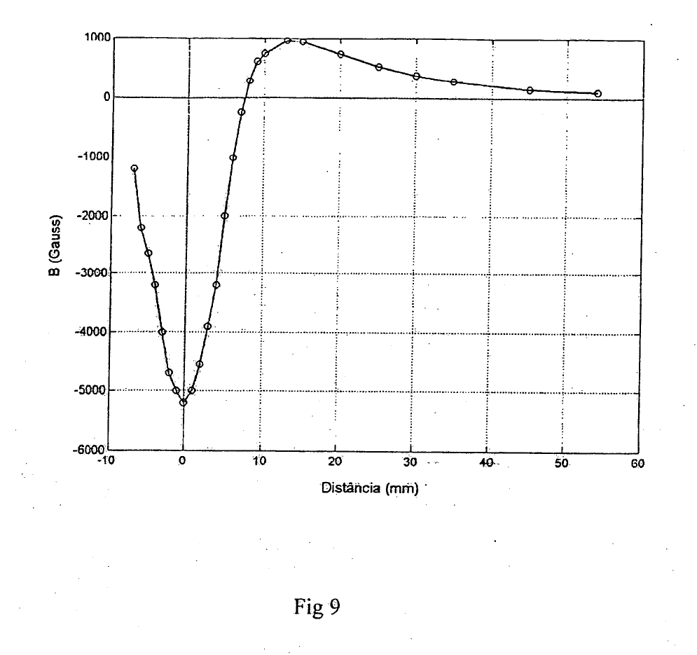

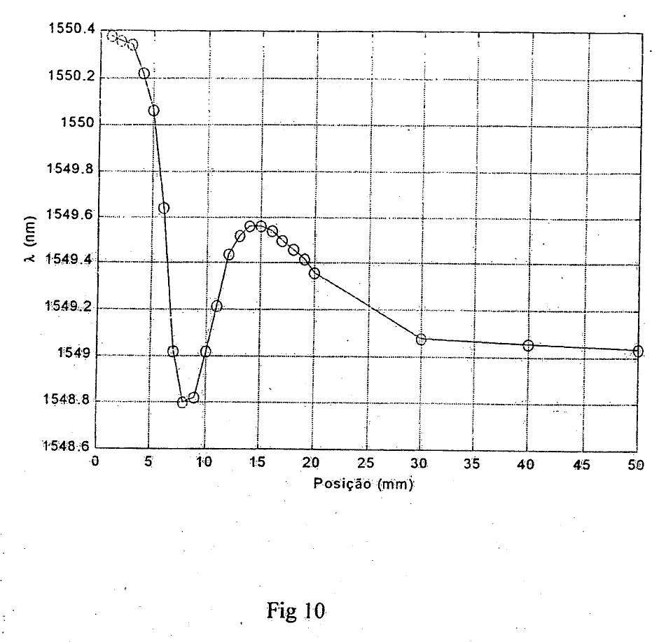

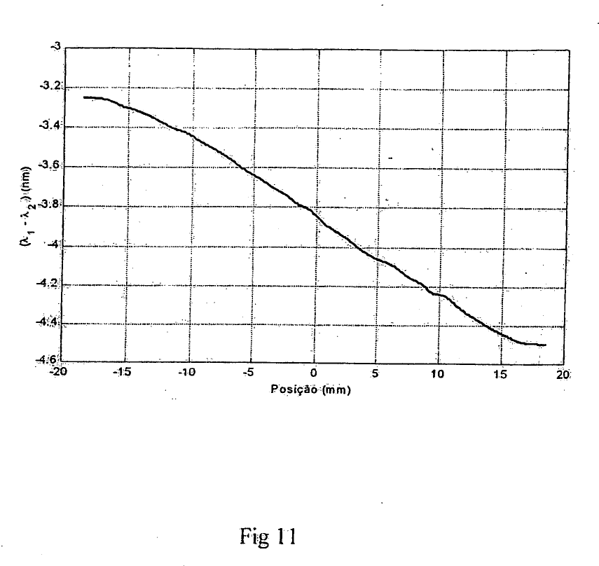

However, the very complex geometry of magnet 1 also translates into a magnetic field whose spatial dependency is more complex. FIG. 9 shows a graph of the magnetic field in the distance for an application of this third variant of the basic configuration in accordance to the present invention. In the FIG. 10's graph, constructed with measurements obtained from the same application, it can be seen that there is not a one to one relationship between the wave length of one of the sensors and the position of the rod 4 relative to the magnet 1. This problem can be solved by establishing a relationship between the difference (λ₁-λ₂) in the wave lengths of the sensors (3.1 and 3.2), and the position. Then, an iterative process is carried out that alters the distance between Sensors 3.1 and 3.2, with the objective of maximizing the dynamic range of positions, keeping a one to one relationship between the difference of the wave lengths and the position. Taking into consideration this difference between the wave lengths of Sensors 3.1 and 3.2, there is still the advantage of compensation for the possible effect of the temperature. The graph in FIG. 11, constructed from the same application that formed the basis for the construction of FIGS. 9 and 10, is an example relating the difference between the wave lengths of Sensors 3.1 and 3.2 and the position, in this third variant of the basic configuration in accordance with an example embodiment of the present invention.

In relation to the existing position transducers, the invention presents innumerable advantages propitiated by optical fiber technology: its great simplicity of construction, reduced size and weight, the possibility of making measurements in aggressive environments such as, for example, at high temperatures, and the possibility of taking remote readings, without needing electronic circuits at the point of measurement. Moreover, in contrast with transducers based on electrical induction, the present invention avoids the use of cables and electrical circuits close to the place of measurement. However, in the same manner as those transducers, the present invention is capable of supplying measurements of great precision and trustworthiness, because, due to the absence of physical contact with the magnetic field source, the sensing element does not wear out.

The device, in accordance with example embodiments of the present invention, offers other advantages due to the use of existing optical fiber transducers: it can easily be multiplexed, it does not present problems with surfaces, whether they are clean or not or have a highly reflective quality, and since the light remains inside the fiber, there is no need to make a mechanical alignment.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. Fiber optic position transducer including:
a magnetic or electromagnetic element,
at least one segment of magnetostrictive material,
at least two Fiber Bragg Grating Sensors,
a rod made of material that is impermeable to magnetic fields, and
an optical fiber,
wherein
at least one of said two sensors is fixed to a said segment of magnetostrictive material, at least one of said segments of magnetostrictive material is fixed to said rod, and the distortion of the rod relative to the magnetic or electromagnetic element is limited to the direction of the rod's axis.

2. Fiber optic position transducer in accordance with claim 1, wherein said at least two Fiber Bragg Grating Sensors having different wave lengths.

3. Fiber optic position transducer in accordance with claim 1, wherein said Fiber Bragg Grating Sensors are made of the same optical fiber.

4. Fiber optic position transducer in accordance with claim 1, operating connected to a remote reading system containing a broadband light source, a coupler and a spectral analysis and detection system.

5. A fiber optic position transducer in accordance with claim 1, operating connected to an applicable configuration for the interrogation of Fiber Bragg Grating Sensors.

6. Fiber optic position transducer in accordance with claim 1, wherein only a single segment of magnetostrictive material is provided, with only one of the Fiber Bragg Grating Sensors fixed upon the segment.

7. Fiber optic position transducer in accordance with claim 1, wherein only a single segment of magnetostrictive material is provided, with both Fiber Bragg Grating Sensors fixed to the segment, oriented in different directions.

8. Fiber optic position transducer in accordance with claim 1, wherein each of the Fiber Bragg Grating Sensors is fixed to a different segment of magnetostrictive material.

9. Fiber optic position transducer in accordance with claim 8, having segments of magnetostrictive material spaced along the rod in such a way as to allow a one to one identification of the rod's position in relation to the magnetic and electromagnetic element.

10. Fiber optic position transducer in accordance with claim 1, wherein the magnetic or electromagnetic element is solid and is located in front of or at the side of the rod.

11. Fiber optic position transducer in accordance with claim 1, wherein the magnetic or electromagnetic element contains a hole and is crossed through by the rod.

12. Fiber optic position transducer in accordance with claim 1, wherein the magnetic or electromagnetic element is made of NdFeB (Neodymium Iron Boron).

13. Fiber optic position transducer in accordance with claim 1, wherein the segments of magnetostrictive material are made of metal alloys of TbDyFe (Terbium, Dysprosium and Iron).

14. Fiber optic position transducer in accordance with claim 13, wherein the segments of magnetostrictive material are made of TX or Terphenol-D.

15. Fiber optic position transducer in accordance with claim 1, disposed in the interior of an oil well.

16. Fiber optic position transducer in accordance with claim 15, characterized by being situated in an outflow control valve.

17. Calibration process for a position transducer including a magnetic or electromagnetic element, at least one segment of magnetostrictive material, at least two Fiber Bragg Grating Sensors, a rod made of material that is impermeable to magnetic fields, and an optical fiber, wherein at least one of said two sensors is fixed to a said segment of magnetostrictive material, at least one of said segments of magnetostrictive material is fixed to said rod, and the distortion of the rod relative to the magnetic or electromagnetic element is limited to the direction of the rod's axis, the process comprising:
carrying out a pre-calibration with at least one fixed sensor respectively in at least one segment of magnetostrictive material in such a way that each temperature calibration curve of the sensor already has the effects of thermal distortion of the magnetostrictive material built-in and using the wave lengths reflected by each sensor as well as information referencing the distortions undergone by each sensor, applying the equation:
Δλ_{B}/λ_{B}=K₁ΔT+K₂ε (equation I) for each of the sensors.

18. Calibration process for the position transducer including a magnetic or electromagnetic element, at least one segment of magnetostrictive material, at least two Fiber Bragg Grating Sensors, a rod made of material that is impermeable to magnetic fields, and an optical fiber, wherein at least one of said two sensors is fixed to a said segment of magnetostrictive material, at least one of said segments of magnetostrictive material is fixed to said rod, and the distortion of the rod relative to the magnetic or electromagnetic element is limited to the direction of the rod's axis, the process comprising:
calibrating using values that one of the wave lengths takes on as a function of the relative position of rod 4 to magnet 1, with the possible temperature effects deducted.
